(19) United States
(12) Patent Application Publication
(10) Pub. No.: US 2009/0104476 A1
(43) Pub. Date: Apr. 23, 2009

(54) FUEL CELL STACK WITH ASYMMETRIC DIFFUSION MEDIA ON ANODE AND CATHODE

(75) Inventors: Chunxin Ji, Pennfield, NY (US); Steven R. Falta, Honeoye Falls, NY (US); Jeanette E. Owejan, Honeoye, NY (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/873,518

(22) Filed: Oct. 17, 2007

(51) Int. Cl. H01M 2/00; H01M 8/00

(52) U.S. Cl. 429/12

(57) ABSTRACT

The present invention provides a fuel cell having a first diffusion and a second diffusion media having a membrane electrode assembly disposed therebetween. The first diffusion media includes a first set of material characteristics and the second diffusion media includes a second set of material characteristics. The first set of material characteristics has at least one material characteristic substantially different from those same material characteristics of the second set of material characteristics. The difference in material characteristics provides for enhancing water management across a major face of the second diffusion media.

### FIELD OF THE INVENTION

The present invention relates to fuel cells and more particularly to fuel cells that have different diffusion media on the anode and cathode sides of the cell.

### BACKGROUND OF THE INVENTION

Fuel cells have been used as a power source in many applications. For example, fuel cells have been proposed for use in electrical vehicular power plants to replace internal combustion engines. Proton exchange membrane (PEM) type fuel cells include a membrane electrode assembly (MEA) comprising a thin, proton transmissive, non-electrically conductive, solid polymer electrolyte membrane having the anode catalyst on one face and the cathode catalyst on the opposite face. The MEA is sandwiched between a pair of non-porous, electrically conductive elements or plates which (1) serve as current collectors for the anode and cathode, and (2) contain appropriate channels and/or openings formed therein for distributing the fuel cell's gaseous reactants over the surfaces of the respective anode and cathode catalysts.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly (MEA) described earlier, and each such MEA provides its increment of voltage. A group of adjacent cells within the stack is referred to as a cluster.

In PEM fuel cells, hydrogen (H₂) is the anode reactant (i.e., fuel) and oxygen is the cathode reactant (i.e., oxidant). The oxygen can be either a pure form (O₂) or air (a mixture of O₂ and N₂). The solid polymer electrolytes are typically made from ion exchange resins such as perfluoronated sulfonic acid. The anode/cathode typically comprises finely divided catalytic particles, which are often supported on carbon particles, and mixed with a proton conductive resin. The catalytic particles are typically costly precious metal particles. As such these MEAs are relatively expensive to manufacture and require certain conditions, including proper water management and humidification and control of catalyst fouling constituents such as carbon monoxide (CO), for effective operation.

The electrically conductive plates sandwiching the MEAs may contain a reactant flow field for distributing the fuel cell's gaseous reactants (i.e., hydrogen and oxygen in the form of air) over the surfaces of the respective cathode and anode. These reactant flow fields generally include a plurality of lands that define a plurality of flow channels therebetween through which the gaseous reactants flow from a supply header at one end of the flow channels to an exhaust header at the opposite end of the flow channels.

Interposed between the reactant flow fields and the MEA is a diffusion media serving several functions. One of these functions is the diffusion of reactant gases from the various flow channels to the major face of the MEA and the respective catalyst layer. Another is to diffuse reaction products, such as water, across the fuel cell. A third function is to adequately support the MEA between the various lands across the flow channels. In order to properly perform these functions, the diffusion media must be sufficiently porous while maintaining certain mechanical properties. The porosity is required to ensure proper reactant distribution across the face of the MEA. The mechanical properties are required to maintain sufficient contact between MEA and the diffusion media over the channel region and also to prevent the MEA from damage when assembled within the fuel cell stack.

The flow fields are carefully sized so that at a certain flow rate of a reactant a specified pressure drop between the flow field inlet and the flow field outlet is obtained. At higher flow rates, a higher pressure drop is obtained while at lower flow rates, a lower pressure drop is obtained.

It is desirable to have some compressibility in the diffusion media to account for plate variation. However, when a force acts on a compressible diffusion media, portions of the diffusion media may intrude into the channels of the bipolar plate. This intrusion results in a pressure drop which may be undesirable. Likewise, non uniform intrusion into different cells will cause uneven flow distribution into different cells. The effect of diffusion media intrusion is greater on the anode side and less on the cathode side since anode hydrogen fuel has a much lower flow rate and usually has a lower stoichiometry.

Other situations also exist where differing material characteristics between anode and cathode sides of a fuel cell may be beneficial. A few examples of these characteristics include porosity, permeability, surface free energy and microporous layer thickness. It would be beneficial therefore to have different diffusion media for the anode and cathode sides of a fuel cell.

### SUMMARY OF THE INVENTION

The present invention provides a fuel cell having a first diffusion media and a second diffusion media having a membrane electrode assembly disposed therebetween. The first diffusion media includes a first set of material characteristics and the second diffusion media includes a second set of material characteristics. The first set of material characteristics has at least one material characteristic substantially different from at least one material characteristic of the second set of material characteristics. The difference in material characteristics provides for enhanced fuel cell/stack performance.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a monocell fuel cell according to the principles of the present invention;

FIG. 2 is a partial perspective cross-sectional view of a portion of a PEM fuel cell stack containing a plurality of the fuel cells of FIG. 1 showing layering including diffusion media;

FIG. 3 is a detail illustrating an asymmetric diffusion media on anode and cathode; and

FIG. 4 is a chart illustration experimental test data of a small scale fuel cell with a symmetric diffusion media on the anode and cathode.

### DETAILED DESCRIPTION OF THE PREFERRED EMBODIMENT

The following description of the preferred embodiment is merely exemplary in nature and is in no way intended to limit the invention, its application, or uses.

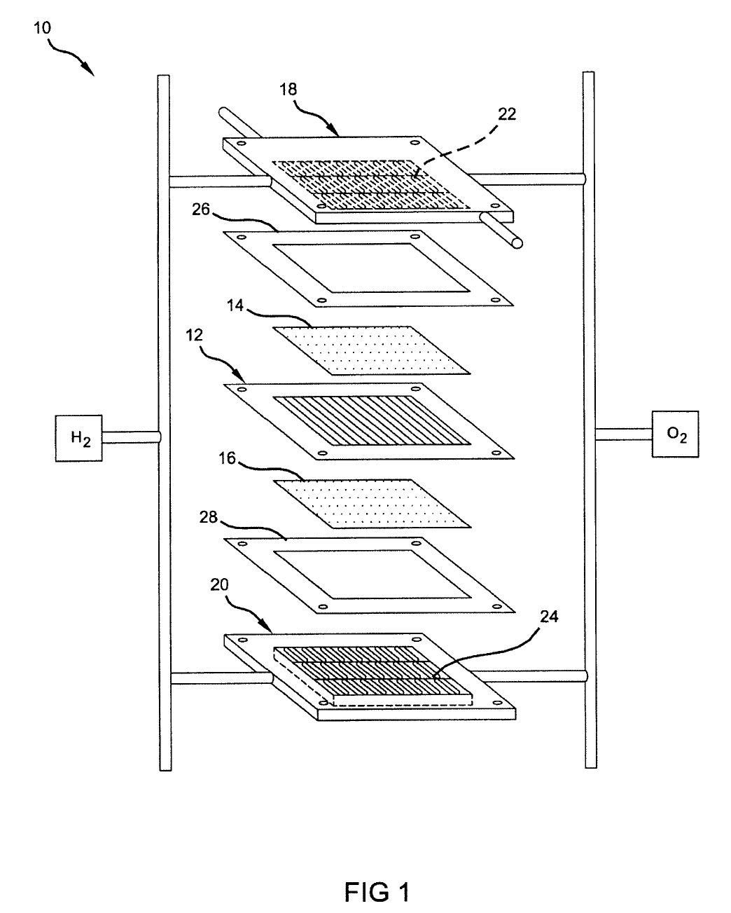

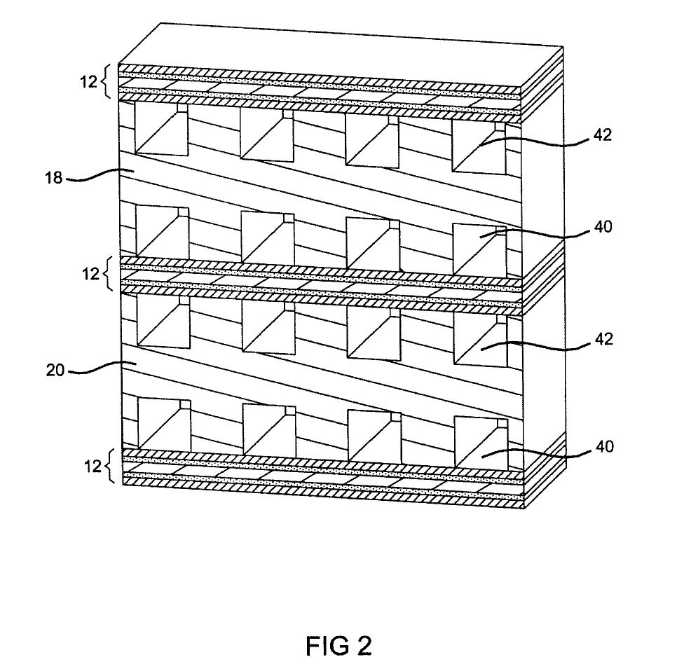

With reference to FIG. 1, a monocell fuel cell 10 is shown having an MEA 12 and a pair of diffusion media (DM) 14, 16 sandwiched between a pair of electrically conductive unipolar plates 18, 20. It will be appreciated, however, that the present invention, as described hereinbelow, is equally applicable to fuel cell stacks that comprise a plurality of cells arranged in series as shown in FIG. 2 and separated from one another by bipolar electrode plates commonly known in the art. For brevity, further reference may be made to either the fuel cell stack or to an individual fuel cell 10, however, it should be understood that the discussions and descriptions associated with fuel cell stack are also applicable to individual fuel cells 10 and vice versa and are within the scope of the present invention.

The plates 18, 20 may be formed of carbon, graphite, coated plates or corrosion resistant metals. The MEA 12 and unipolar plates 18, 20 are clamped together between end plates (not shown). The unipolar plates 18, 20 each contain a plurality of flow channels 22, 24 respectively that form a flow field for distributing reactant gases (i.e. H₂ and O₂) to opposing faces of the MEA 12. In the case of a multi-cell fuel cell stack, a flow field is formed on either side of a bipolar plate, one for H₂ and one for O₂. Nonconductive gaskets 26, 28 provide seals and electrical insulation between the several components of the fuel cell 10.

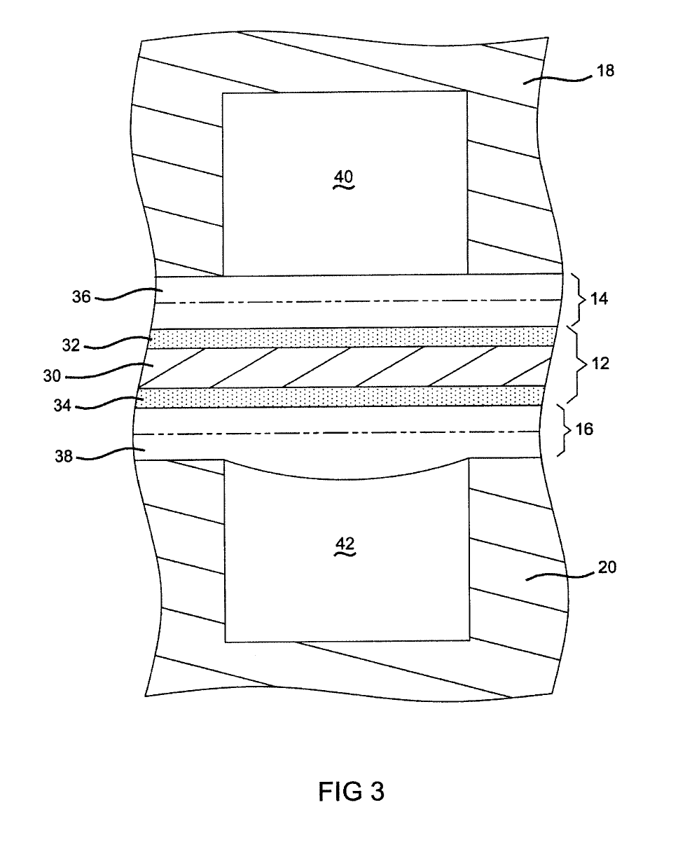

With particular reference to FIGS. 2 and 3, the MEA 12 includes a membrane 30 sandwiched between an anode catalyst layer 32 and a cathode catalyst layer 34. An anode DM 14 is interposed between the MEA 12 and the upper plate 18. A cathode DM 16 is interposed between the MEA 12 and the lower plate 20. As shown, H₂ flow channels 40, forming the anode side H₂ flow field, lie immediately adjacent the anode DM 14 and are in direct fluid communication therewith. Similarly, O₂ flow channels 42, forming the cathode side O₂ flow field, lie immediately adjacent the cathode DM 16 and are in direct fluid communication therewith. The membrane 30 is preferably a proton exchange membrane (PEM) and the cell having the PEM is referred to as a PEM fuel cell.

The anode and cathode DM 14, 16 may each include a microporous layer (MPL) 36, 38 located on the side of the anode or cathode DM 14, 16 proximate the respective catalyst layer 32, 34. The MPL 36, 38 has a thickness that may include both a layer extending above the surface of the DM 14, 16 and a portion penetrating the surface of the DM 14, 16. For illustration, the MPL 36, 38 is shown by broken line in FIGS. 2 and 3. The MPL 36, 38 typically increases the surface contact between the DM 14, 16 and the anode or cathode catalyst layers 32, 34 and helps water management by preventing a water film from formation adjacent to the MEA.

In operation, the H₂-containing reformate stream or pure H₂ stream (fuel feed stream) flows into an inlet side of the anode side flow field through channel 40 and concurrently, the air or pure O₂ stream (oxidant feed stream) flows into an inlet side of the cathode side flow field through channel 42. The fuel feed stream flows through anode DM 14 and the presence of the anode catalyst 32 causes the H₂ to be oxidized into hydrogen ions, or protons (H⁺), with each giving up two electrons. The electrons travel from the anode side to an electric circuit (not shown), enabling work to be performed (i.e. rotation of an electric motor). The membrane layer 30 enables protons to flow through while preventing electron flow therethrough. Thus, the protons flow directly through the membrane to the cathode catalyst 34. On the cathode side, the protons combine with the oxidant feed stream and electrons, thereby forming water.

Still referring to FIGS. 2 and 3, channels 40, 42 and MEA 12 are shown. Flow channels 40, 42 are sized to have a specific flow area through which the feed streams flow. The flow area is sized so that at a certain flow rate of the feed streams through the flow channels 40, 42, a specific pressure drop occurs across the flow field 22, 24. That is, at a certain flow rate the gaseous reactants flowing through the channels 40, 42 will experience a pressure drop between an inlet and an outlet of the flow field 22, 24.

Changing the characteristics of the DM 14, 16 based on whether it functions as an anode DM 14 or a cathode DM 16 has been found to improve fuel cell 10 system performance. Specifically, it has been determined that the mechanical characteristics, structural characteristics, thermal resistance and surface free energy of the DM 14, 16 impact on the performance of a fuel cell 10. The mechanical characteristics may include compressibility and bending stiffness. The structural characteristics may include thickness, porosity, gas permeability, gas diffusivity and MPL thickness.

For example, having an anode side DM 14 that is stiffer than a cathode side DM 16 allows the anode channels to be least affected by the DM intrusion variation and thus improve performance while still allowing the cathode side DM 16 to account for plate variation. The compressibility of a DM may be characterized as the deflection of the media as a function of a compressive force. Depending on the thickness and compressibility of the DM, the DM may partially intrude into the flow channels, such as illustrated in by DM 16 intruding into channel 42, thereby effectively reducing the flow area in FIG. 3 to block the flow of gas. The anode of the fuel cell is generally operated at a relatively lower stoichiometry and thus most of the pure H₂ is consumed near the anode gas outlet. The uneven DM intrusion into anode flow channels in different cells will result in different flow distribution. In other words, different stoichiometry in different cells occur, and these cells might experience under stoichoimetry operation and thus affect the overall stack performance and durability. The compressibility of the anode gas DM 14 may be decreased or the flexural modulus may be increased in order to reduce channel intrusion. Flexural modulus generally defines the bending behavior of a material. The flexural modulus of a material can generally be characterized using a 3 point bending test [ASTM D790].

Air is normally used as the oxidant in the cathode side, which contains 21% O₂ and 78% N₂. The N₂ is not consumed in the fuel cell and the cathode is normally operated at relatively high stoichiometry in comparison to the anode side. As a result, the cathode side can accommodate greater cell to cell flow variation without impacting cell performance. This allows the cathode side to be less sensitive to differences in cell to cell DM channel intrusion. Therefore, the cathode side DM 16 may be less stiff than the anode side DM 14.

In another example, the product water is produced at the cathode side of the fuel cell. Water is transported from the anode side to the cathode side through osmotic drag. At high current density operating conditions, this results in a much higher water concentration in the cathode side than the anode side, and thus causes uneven membrane hydration across the proton conductive membrane and lowers the membrane proton conductivity. It has been found that using a DM without MPL and with a lower thermal resistance on the anode side is beneficial for high current density operations. On the other hand, very often fuel cells might be operated at dryer operating conditions and it is especially favorable for automotive application. Using a DM on the anode side with a lower water vapor diffusivity will help maintaining the membrane hydration.

Other parameters may be altered as well, such as the surface free energy of the DM. Providing a greater surface free energy on the anode side DM 14 than the cathode side DM 16 has proven beneficial. Surface free energy can be used to characterize the hydrophobicity of a DM. Surface free energy defines the work required to enlarge the surface area of matter. A liquid completely wets a solid when the contact angle of the liquid on the surface of the solid is 0° and can be considered to be resistant to wetting when the contact angle is larger than 90°. Therefore, having a greater surface free energy typically implies a greater hydrophilicity.

The anode side DM 14 may also have a less open pore structure and a thicker MPL coating 36 to maintain a desirable hydration level for the proton conductive membrane under dry operating conditions. The less open pore structure may include a decreased porosity and/or permeability relative to the cathode DM 16. The porosity is a function of the bulk density of the DM, which can be calculated from a real mass and thickness. The permeability may be a liquid or gas permeability. A variety of methods may be used to characterize the permeability of a DM. For gas permeability, a gas flow rate may be defined through a given sample area at a given pressure drop. For low flow materials, such as those with a MPL 36, 38, this may be expressed as the time required to pass a certain volume of flow through a given sample size at a given pressure drop. Liquid permeability may be characterized as the liquid flow rate through a DM at a given pressure drop. A liquid permeability test may be used. In this method, a column of liquid is put on the top of a porous media, and a pressure is then applied to force the liquid through the sample. This less open pore structure DM 14 structure on the anode side may naturally result in a stiffer substrate with less intrusion into the channels and thus reduce uneven reactant gas flow distribution from cell to cell.

The cathode side may further include an optimized MPL coating 38 having deeper penetration into the DM 16 for better cathode side water management. This feature has been found to be effective in removing product water by preventing the formation of a continuous water film inside of the DM 16 substrate, thereby reducing the cathode mass transport loss.

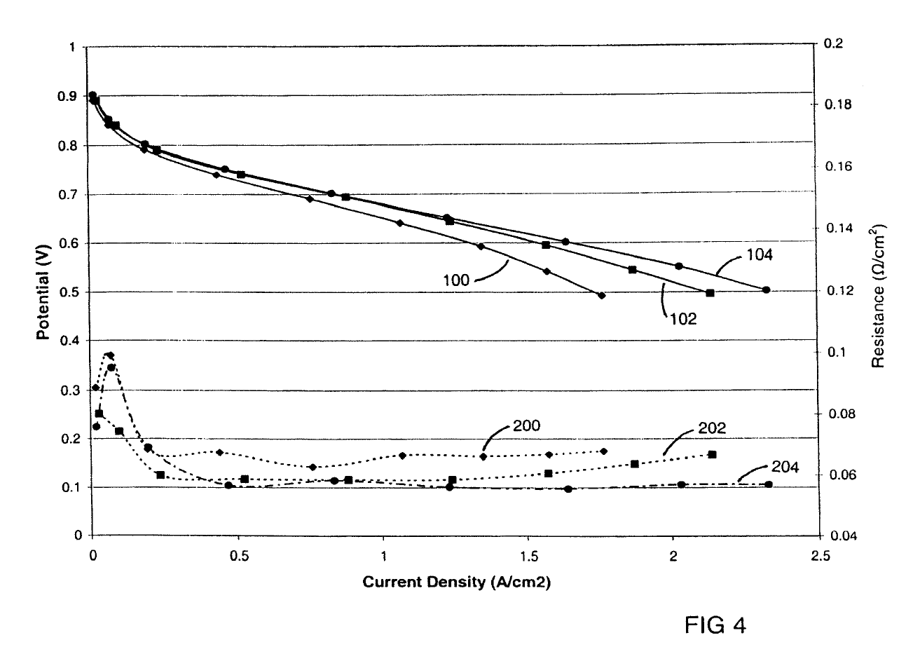

FIG. 4 illustrates testing data for three (3) small scale fuel cell testing data to demonstrate the beneficial effects of using asymmetric DM on the anode and cathode of the fuel cell as described herein. This data is based on testing of a single-celled fuel cell having an active area of 50 cm² with reactant gases transported through a serpentine flow field at a pressure of approximately 50 kPa_{g}. The cell temperature was approximately 80° C. The dewpoint of the anode and cathode gases was approximately 70° C. and the relative humidity of the reactant gases at the exit was 110%.

Sample 1 was a control cell with a symmetric anode DM and cathode DM (i.e., with the same properties). Samples 2 and 3 were test cells with different anode DMs such that the anode and cathode DM are asymmetric. Specifically, the relative properties of the anode DM for the samples are set forth in Table 1 below.

TABLE 1

| Property | Sample | | Sample | | Sample |
|---|---|---|---|---|---|
| Stiffness | A | < | B | = | C |
| Flexural Modulus | A | < | B | = | C |
| MPL Thickness | C | < | B | < | A |
| Thermal Resistance | C | = | B | < | A |
| Water Vapor Diffusivity | C | = | B | < | A |
| Porosity | A | < | B | < | C |
| Substrate Density | A | < | B | = | C |
| Permeability | A | < | B | < | C |

Data plots 100, 102 and 104 represent the incremental voltage potential (V) generated by Samples 1, 2 and 3, respectively over a range of current densities. Data plots 200, 202 and 204 represent the resistance (Ω/cm²) across Samples 1, 2 and 3, respectively.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell comprising:
a first diffusion media having a first set of material characteristics;
a second diffusion media having a second set of material characteristics, said first set of material characteristics having at least one material characteristic substantially different from said at least one material characteristic of said second set of material characteristics for enhancing water management across a major face of said second diffusion media; and
a membrane electrode assembly disposed between said first diffusion media and said second diffusion media.

2. The fuel cell of claim 1, wherein said at least one material characteristic from said first and second sets is a mechanical characteristic.

3. The fuel cell of claim 2, wherein said mechanical characteristic includes one of a flexural modulus, and a compressibility.

4. The fuel cell of claim 3, wherein said first diffusion media has a first compressibility and said second diffusion media has a second compressibility, said first compressibility being less than said second compressibility.

5. The fuel cell of claim 3, wherein said first diffusion media has a first flexural modulus and said second diffusion media has a second flexural modulus, a ratio between said first flexural modulus and said second flexural modulus being greater than 1.

6. The fuel cell of claim 1, wherein said first diffusion media has a surface free energy greater than a surface free energy of said second diffusion media.

7. The fuel cell of claim 1, wherein said first diffusion media has a thermal resistance less than the thermal resistance of said second diffusion media

8. The fuel cell of claim 1, wherein said at least one material characteristic for said first and second sets is a structural characteristic.

9. The fuel cell of claim 8, wherein said structural characteristic includes one of a substrate thickness, a porosity, a permeability, a diffusivity and a microporous layer thickness.

10. The fuel cell of claim 9, wherein said first diffusion media has a first substrate thickness and said second diffusion media has a second substrate thickness, a ratio between said first thickness and said second thickness being less than 1.

11. The fuel cell of claim 9, wherein said first diffusion media has a first porosity and said second diffusion media has a second porosity, a ratio between said first porosity and said second porosity being less than 1.

12. The fuel cell of claim 9, wherein said first diffusion media has a first fluid permeability and said second diffusion media has a second fluid permeability, a ratio between said first fluid permeability and said second fluid permeability being less than 1.

13. The fuel cell of claim 12, wherein said first and second fluid permeabilities are gas permeabilities.

14. The fuel cell of claim 12, wherein said first and second fluid permeabilities are liquid permeabilities.

15. The fuel cell of claim 9, wherein said first diffusion media includes a first microporous layer coating proximate said membrane electrode assembly and said second diffusion media includes a second microporous layer coating proximate said membrane electrode assembly.

16. The fuel cell of claim 15, further comprising at least one of a coating thickness and a structural characteristic of said first microporous layer is different from said second microporous layer.

17. The fuel cell of claim 1, wherein said membrane electrode assembly comprises an anode face in contact with said first diffusion media and a cathode face in contact with said second diffusion media.

18. A method of manufacturing a fuel cell stack including at least one fuel cell having first and second electrode plates, a membrane electrode assembly, a first diffusion media disposed between the first electrode plate and the membrane electrode assembly and a second diffusion media disposed between the second electrode plate and the membrane electrode assembly, said method comprising:
selecting a first diffusion media from a group of diffusion media having a first set of material characteristics; and
selecting a second diffusion media from the group of diffusion media having a second set of material characteristics, the second set of material characteristics having at least one material characteristic different from at least one material characteristic of the first set of material characteristics.

19. The method of claim 18, further comprising selecting the second diffusion media having a mechanical characteristic different than the mechanical characteristic of the first diffusion media.

20. The method of claim 19, further comprising selecting the second diffusion media having a flexural modulus different than a flexural modulus of the first diffusion media.

21. The method of claim 19, further comprising selecting the second diffusion media having a compressibility different than a compressibility of the first diffusion media.

22. The method of claim 19, further comprising selecting the second diffusion media having a surface free energy different than a surface free energy of the first diffusion media.

23. The method of claim 18, further comprising selecting the second diffusion media having a structural characteristic different than the structural characteristic of the first diffusion media.

24. The method of claim 23, further comprising selecting the second diffusion media having a porosity different than a porosity of the first diffusion media.

25. The method of claim 23, further comprising selecting the second diffusion media having a permeability different than a permeability of the first diffusion media.

26. The method of claim 22, further comprising selecting the second diffusion media having a microporous layer structure different than a microporous layer structure of the first diffusion media.
